(19) United States
(12) Patent Application Publication
(10) Pub. No.: US 2026/0335758 A1
(43) Pub. Date: Oct. 29, 2026

(54) EXTREME PAI GOW POKER AND METHOD OF ADMINISTERING THEREOF

(71) Applicant: Matthew Tang, Egg Harbor Township, NJ (US)

(72) Inventor: Matthew Tang, Egg Harbor Township, NJ (US)

(21) Appl. No.: 19/700,106

(22) Filed: Jun. 5, 2026

Related U.S. Application Data
(63) Continuation-in-part of application No. 18/588,014, filed on Feb. 27, 2024.

(51) Int. Cl. A63F 1/02; A63F 1/00; A63F 1/06; G07F 17/32

(52) U.S. Cl. CPC A63F 1/02; A63F 1/067; A63F 2001/005; A63F 2001/008; G07F 17/3293

(57) ABSTRACT

The present invention is a Pai Gow Poker variant game (may also be referred to as “Extreme Pai Gow Poker”). The present invention is also a method of administering or playing the Pai Gow Poker variant game. The present invention is comparable to the basic or traditional Pai Gow Poker game. As a non-limiting example, the high hand (five-card hand) must be higher than the low hand (two-card hand). At least one bonus betting wager or no bonus betting wager may be included. Another bonus, King High bonus, betting wager may further be included. As another non-limiting example, the low hand wager must be either exactly double or exactly triple the amount of the high hand wager. In one embodiment, each player makes a low hand wager and a high hand wager. In an alternative embodiment, a player may elect to place only a low hand wager.

### CROSS-REFERENCE TO RELATED APPLICATIONS

The present application claims the priority benefit of U.S. Nonprovisional patent application Ser. No. 18/588,014, filed on Feb. 27, 2024 and titled “EXTREME PAI GOW POKER AND METHOD OF ADMINISTERING THEREOF”, which claims the priority benefit of U.S. Provisional Patent Application Ser. No. 63/577,161, filed on Apr. 5, 2023 and titled “ASIAN POKER 2.0,” both of which are incorporated herein by reference in their entireties.

### BACKGROUND OF THE INVENTION

### Field of the Invention

The present invention relates to the general field of games of chance and, more particularly, to an improvement, a variant, or a modified version in the game of Asia Poker. More specifically, the present invention is a Pai Gow Poker variant game, which may be referred to as “Extreme Pai Gow Poker.” The present invention is also a method of administering or playing the Pai Gow Poker variant game according to the rules of this Extreme Pai Gow Poker variant game.

### Description of the Related Art

The well-known game of Asia Poker, often referred to as “Pai Gow Poker,” is gaining increased acceptance by recreational game players, gamblers, and owners, developers, investors, and/or manufacturers of gambling entities and devices and/or game entities and devices (such as, but not limited to, casinos; venues, centers and establishments (such as, but not limited to, horse racing tracks, sports stadiums, sports venues, restaurants, bars, and airports) that lawfully allow gambling; gambling websites (via an electronic device, such as, but not limited to, a computer, an electronic tablet, a smartphone, a smartwatch, a game console, and any electronic device known to one of ordinary skill in the art); game websites (via an electronic device); gambling apps (via an electronic device); game apps (via an electronic device); electronic games; video games; and gambling devices and machines (such as, but not limited to, slot machines, kiosks, and table machines)). In one example of a traditional Pai Gow Poker game, a player is dealt seven cards which are arranged by the player to make two hands, viz., a two-card hand (low hand) and a five-card hand (high hand). The only requirement in forming the hands is that the low hand must be of a lower rank than the high hand. The ranking of the hands are the same as in traditional poker with the exception that the joker can be used to represent an ace or to represent one card of either a straight or a flush. Because of the use of a joker, five aces is the highest possible hand.

The game is started by each player placing a bet (“ante”). The dealer then deals seven cards to himself and each of the players (such as, but not limited to, six players). Usually, the dealer is a casino employee (a non-limiting example) and the players compete against the casino (a non-limiting example) by attempting to beat the dealer, although the dealer can be a customer or player (as also discussed below).

In playing the game, when the player forms his low hand and his high hand so that they are both respectively higher in rank than the low hand and the high hand of the dealer, the player is declared to be the winner and the dealer is declared to be the loser. Conversely, when the player forms his low hand and his high hand so that they are both respectively lower in rank than the low hand and high hand of the dealer, the player is the loser and the dealer is the winner. The dealer wins all tied hands. Further, if the player wins one hand and the dealer wins the other hand, a “push” is declared and no one wins. If a player wins both hands, the bet made is matched, i.e., an even money bet is paid, less a commission of typically 5%.

As will be evident from the foregoing, no money exchanges hands, i.e., the bet is neither won or lost, when there is a push. It has been estimated that approximately forty percent of the outcomes in traditional Pai Gow Poker are pushes. The occurrence of a push or tie obviously diminishes the excitement of a hand, and because there are so many pushes, traditional Pai Gow Poker has limited appeal for many people. Moreover, recreational game players, gamblers, and owners, developers, investors, and/or manufacturers of gambling entities and devices and/or gaming entities and devices (such as those described above in this application) may prefer a Pai Gow Poker variant game wherein there are more winning hands given that, in the long run, the owners, developers, investors, and/or manufacturers of gambling entities and devices and/or gaming entities and devices will come out ahead because tie hands go to the owners, developers, investors, and/or manufacturers of gambling entities and devices and/or gaming entities and devices, and the owners, developers, investors, and/or manufacturers of gambling entity and/or gaming entity receives a commission when the dealer wins or loses its hands.

The present invention, which may be referred to as “Extreme Pai Gow Poker,” overcomes one or more of the shortcomings of the traditional Pai Gow Poker game and other versions of Pai Gow Poker games. The Applicant is unaware of inventions or patent documents, taken either singly or in combination, which are seen to describe the present invention as claimed.

One advantage of the present invention and the method thereof of the present invention is that the owners, developers, investors, and/or manufacturers of gambling entities and devices and/or gaming entities and devices will come out ahead because tie hands go to or is considered a win for the dealer (or the owners, developers, investors, and/or manufacturers of gambling entities and devices and/or gaming entities and devices).

Another advantage of the present invention and the method thereof is that the game may be offered without requiring a commission on winning wagers. Unlike traditional Pai Gow Poker, which generally charges a commission of approximately five percent (5%) on winning player wagers, the present invention utilizes one or more predetermined dealer-hand outcomes to compensate for the elimination of such commission. In one embodiment, when the dealer's initial seven-card hand qualifies as a king-high no-pair hand, all primary wagering positions are resolved as a push. By replacing the traditional commission with a game-rule-based resolution event, the present invention simplifies game administration, enhances player appeal, and preserves a mathematical advantage for the gaming establishment.

### SUMMARY OF THE INVENTION

As a non-limiting embodiment, the present invention is a Pai Gow Poker variant game (may also be referred to as “Extreme Pai Gow Poker”) preferably played with one standard fifty-three card deck, which preferably includes one joker that acts as a “bug” (that is, it may be the fifth card in any straight, flush, or straight flush; otherwise, it counts as a suitless ace). As another non-limiting embodiment, the present invention is preferably also a method of administering or playing the Pai Gow Poker variant game according to the rules of this Pai Gow Poker variant game.

The present invention is comparable to the basic or traditional Pai Gow Poker game in that preferably seven cards are dealt to each of the players for the player to form or create two separate card groups of five cards and two cards. The card groups are designated as a low hand and a high hand by the player. As a non-limiting example, when the cards dealt to a player are divided into the two separate card groups, the high hand (five-card hand) must be higher than the low hand (two-card hand).

As an embodiment and non-limiting example of the present invention, to begin play at or on a gambling entity and device and/or a game entity and device (such as, but not limited to, a casino; a venue, a center and an establishment that lawfully allow gambling; a gambling website (via an electronic device, such as, but not limited to, a computer, an electronic tablet, a smartphone, a smartwatch, a game console, and any electronic device known to one of ordinary skill in the art); a game website (via an electronic device); a gambling app (via an electronic device); a game app (via an electronic device); an electronic game; a video game; and a gambling device and machine (such as, but not limited to, a slot machine, a kiosk, and a table machine), there are preferably six players. The maximum number and/or minimum number of players may vary according to that desired by owners, developers, investors, and/or manufacturers of a gambling entity and device and/or a game entity and device. Prior to each player being dealt seven cards (preferably), each player makes two mandatory wagers: a low hand wager and a high hand wager. As a non-limiting example, the high hand wager must be either exactly double or exactly triple the amount of the low hand wager. As another non-limiting example, the low hand wager must be either exactly double or exactly triple the amount of the high hand wager. In one embodiment, each player makes a low hand wager and a high hand wager. In an alternative embodiment, a player may elect to place only a low hand wager.

In addition, one aspect of the present invention concerns the provision of separate bonus wagering or betting on the hand being played. This feature enhances interest and excitement by, inter alia, giving the player additional betting opportunities and enables the player to potentially receive a large payout on a single hand at odds much higher than the fixed 1-to-1 payout of the base game. The bonus wager gives the game more “depth of play” and “completes” the game as it offers player the full gaming experience and a bonus wager where players can wager a small amount of money, without much risk, and have a chance at winning higher amounts of money. In one embodiment, each player has the option of placing an additional bonus wager. As indicated above, the additional bonus wager is independent of, i.e., separate from, the basic wager(s) on the base game. In this regard, a wager(s) must always be placed on the base game. The wager(s) on the base game is referred herein to as the “ante” betting wagers (or low hand (“L”) betting wager and high hand (“H”) betting wager for the present invention). Each of the low hand betting wager and high hand betting wager must always be at or above a minimum wager for the table (the “table minimum”). At least one bonus (“B”) betting wager or no bonus betting wager can be made in addition to the low hand betting wager and high hand betting wager. A bonus betting wager(s) can be made in varying denominations. As a non-limiting example of the present invention, another bonus, King High bonus (“K”), betting wager may be included. In no event, however, can the sum of all betting wagers (i.e., low hand, high hand, bonus, and King High bonus) be above a maximum wager for the table (the “table maximum”).

Each player then receives seven cards preferably face-down, and the dealer also receives seven cards, face-down. When multiple players are playing, players may not share information about their hands.

The dealer will then reveal their cards and set their two separate hands face-up according to the house way used. A typical Nevada house way may be used (based on that employed by the Golden Nugget in 2007), but any standard, modern house way designed for a “bug-only” Joker wild can be used with expected differences in the hundredths of a percent of a unit at most.

Each player will then form or create two separate card hands from their seven dealt cards and then set their seven dealt cards into a two-card low hand and a five-card high hand, in standard pai gow poker fashion.

If the dealer's cards are a king-high no-pair, then all low hand and high hand betting wagers are pushed. Otherwise, the player's two hands will be compared to the dealer's two hands, with the house winning “copied” hands in standard pai gow fashion, with one wager for each hand; the low hand wager resolved by comparing the two-card hands, and the high hand wager resolved by comparing the five-card hands.

Irrespective of the resolution of the “low hand” and “high hand” betting wagers, all proposition betting wagers are resolved as described above.

All cards are collected and a new round may begin.

In summary, in order to beat the dealer and come out ahead betting wise (not considering the results of the proposition wagers) for a particular round of this Extreme Pai Gow Poker variant game, a player needs to win both the high hand and the low hand, or win the low hand while losing the high hand.

### BRIEF DESCRIPTION OF THE DRAWING(S)

FIG. 1 is a perspective view of an embodiment of a two-hand, Extreme Pai Gow Poker variant game according to the present invention; and

FIG. 2 is a perspective view of another embodiment of a two-hand, Extreme Pai Gow Poker variant game according to the present invention.

It should be understood that the above-attached figures are not intended to limit the scope of the present invention in any way.

### DETAILED DESCRIPTION OF THE PREFERRED EMBODIMENTS

As a non-limiting embodiment, the present invention is a Pai Gow Poker variant game (may also be referred hereinafter as “Extreme Pai Gow Poker”) preferably played with one standard fifty-three card deck, which preferably includes one joker that acts as a “bug” (that is, it may be the fifth card in any straight, flush, or straight flush; otherwise, it counts as a suitless ace). As another non-limiting embodiment, the present invention is also a method of administering or playing the Pai Gow Poker variant game according to the rules of this Pai Gow Poker variant game.

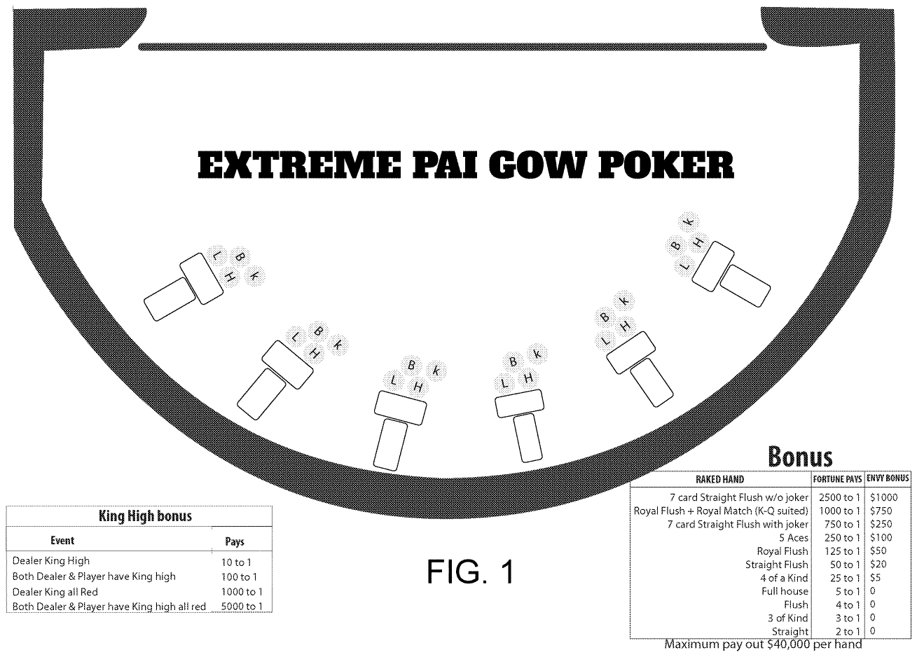

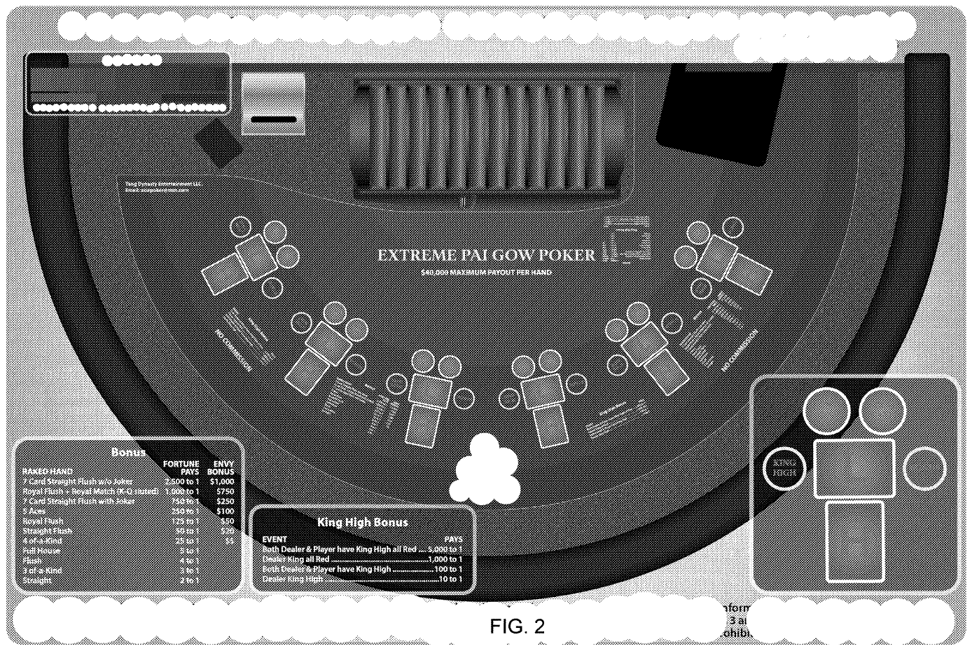

The present invention, such as that shown in FIGS. 1 and 2, is comparable to the basic or traditional Pai Gow Poker game, in that preferably seven cards are dealt to each of the players for the player to form or create two separate card groups of five cards and two cards. The card groups are designated as a low hand and a high hand by the player. As a non-limiting example, when the cards dealt to a player are divided into the two separate card groups, the high hand (five-card hand) must be higher than the low hand (two-card hand).

As an embodiment and non-limiting example of the present invention, to begin play at or on a gambling entity and device and/or a game entity and device (such as, but not limited to, a casino, a venue, a center and an establishment (such as, but not limited to, horse racing tracks, sports stadiums, sports venues, restaurants, bars, and airports) that lawfully allow gambling; a gambling website (via an electronic device, such as, but not limited to, a computer, an electronic tablet, a smartphone, a smartwatch, a game console, and any electronic device known to one of ordinary skill in the art); a game website (via an electronic device); a gambling app (via an electronic device); a game app (via an electronic device); an electronic game; a video game; and a gambling device and machine (such as, but not limited to, a slot machine, a kiosk, and a table machine), there are preferably six players. The maximum number and/or minimum number of players may vary according to that desired by owners, developers, investors, and/or manufacturers of a gambling entity and device and/or a game entity and device. Prior to each player being dealt seven cards (preferably), each player makes two mandatory wagers: a low hand wager and a high hand wager. As a non-limiting example, the high hand wager must be either exactly double or exactly triple the amount of the low hand wager. As another non-limiting example, the low hand wager must be either exactly double or exactly triple the amount of the high hand wager. In one embodiment, each player makes a low hand wager and a high hand wager. In an alternative embodiment, a player may elect to place only a low hand wager.

Each of FIGS. 1 and 2 shows a non-limiting, illustrative table 10,110 (which allows for Extreme Pai Gow Poker of the present invention to be played on) having a dealer position 12,112 and six player positions 14a-14f,114a-114f for preferably six players. As a non-limiting example, one player may be permitted to play more than one corresponding player positions 14a-14f,114a-114f. With regard to each player position 14a-14f,114a-114f, there are preferably three wager betting areas (or four wager betting areas, when a King High bonus wager is included) marked at the corresponding player position 14a-14f,114a-114f: (1) a low hand (“L”) wager betting area 16a-16f,116a-116f; (2) a high hand (“H”) wager betting area 18a-18f,118a-118f (preferably positioned or located side-by-side with the low hand wager betting area 16a-16f,116a-116f); and (3) a bonus (“B”) wager betting area 20a-20f, 120a-120f (preferably positioned or located above and central to both of the “L” and “H” wager betting areas 16a-16f, 18a-18f, 116a-116f,118a-118f as viewed by each player). When there are four wager betting areas when a King High bonus wager is included, a King High bonus (“K”) wager betting area 22a-22f, 122a-122f (preferably positioned or located above the “H” wager betting areas 18a-18f,118a-118f and proximate to “B” wager betting area 20a-20f,120a-120f as viewed by each player. In addition, as also shown on FIGS. 1 and 2, a non-limiting example of a chart or guide 30,130 for the bonus wager is provided on the table or with the game for the players to view. Furthermore, as also shown on FIGS. 1 and 2, a non-limiting example of a chart or guide 40,140 for the King High bonus wager is also provided on the table or with the game.

In addition, one aspect of the present invention concerns the provision of separate bonus wagering or betting on the hand being played. This feature enhances interest and excitement by, inter alia, giving the player additional betting opportunities and enables the player to potentially receive a large payout on a single hand at odds much higher than the fixed 1-to-1 payout of the base game. The bonus wager, which may be placed at bonus (“B”) wager betting area 20a-20f, 120a-120f gives the game more “depth of play” and “completes” the game as it offers player the full gaming experience and a bonus wager where players can wager a small amount of money, without much risk, and have a chance at winning higher amounts of money. In one embodiment, each player has the option of placing an additional bonus wager. As indicated above, the additional bonus wager is independent of, i.e., separate from, the basic wager on the base game. In this regard, a wager(s) must always be placed on the base game. The wager(s) on the base game is referred herein to as the “ante” betting wager (or low hand (“L”) betting wager and high hand (“H”) betting wager for the present invention). Each of the low hand betting wager and high hand betting wager must always be at or above a minimum wager for the table (the “table minimum”). At least one bonus (“B”) betting wager or no bonus betting wager can be made in addition to the low hand betting wager and high hand betting wager. A bonus betting wager(s) can be made in varying denominations. As a non-limiting example of the present invention, another bonus, King High bonus (“K”), betting wager may be included. In no event, however, can the sum of all betting wagers (i.e., low hand, high hand, bonus, and King High bonus) be above a maximum wager for the table (the “table maximum”).

In alternative embodiments, different payout schedules may be utilized. As a non-limiting example, the following are results of how the King High bonus wager works and how a King High bonus is paid out:
a. Dealer King High: Player wins if the Dealer's seven card hand is a king-high no pair, which pays at a rate of 10:1 (a non-limiting example);
b. Both Dealer and Player King High: Player wins if both the Player and the Dealer's seven card hand is a king-high no pair, which pays at a rate of 100:1 (a non-limiting example);
c. Dealer Red King High (also referred to as “Dealer King all Red”): Player wins if the Dealer's seven card hand is a king-high no pair and all seven cards are red, which pays at a rate of 1,000:1 (a non-limiting example);
d. Both King High Red (also referred to as “Both Dealer and Player have King High all Red”): Player wins if both the Player and the Dealer's seven card hand is a king-high no pair and all fourteen cards are red, which pays at a rate of 5,000:1 (a non-limiting example); and
e. Maximum payout per hand is $40,000.

As a non-limiting example of the present invention, players may make one of the four following individual proposition or bonus wager(s):
a. Dealer King High, which wins if the dealer's seven card hand is a king-high no pair, which pays at a rate of 22:1 (a non-limiting example);
b. Dealer Red King High, which wins if the dealer's seven card hand is a king-high no pair and all seven cards are red, which pays at a rate of 5,000:1 (a non-limiting example);
c. Both King High, which wins if both the player and the dealer's seven card hand is a king-high no pair, which pays at a rate of 600:1 (a non-limiting example);
d. Both King High Red, which wins if both the player and the dealer's seven card hand is a king-high no pair and all fourteen cards are red, which pays at a rate of 125 million to 1 (a non-limiting example).

Each player then receives seven cards preferably face-down, and the dealer also receives seven cards, face-down. When multiple players are playing, players may not share information about their hands.

Each player will form or create two separate card hands from their seven dealt cards and then set their seven dealt cards into a two-card low hand and a five-card high hand, in standard pai gow poker fashion.

The dealer will then reveal their cards and set their two separate hands according to the house way used. A typical Nevada house way may be used (based on that employed by the Golden Nugget in 2007), but any standard, modern house way designed for a “bug-only” wild can be used with expected differences in the hundredths of a percent of a unit at most.

If the dealer's hand is or cards are a king-high no-pair, then all low hand and high hand betting wagers are pushed. Otherwise, the player's two hands will be compared to the dealer's two hands, with the house winning “copied” hands in standard pai gow fashion, with one wager for each hand; the low hand wager resolved by comparing the two-card hands, and the high hand wager resolved by comparing the five-card hands.

Irrespective of the resolution of the low hand and high hand betting wagers, all proposition betting wagers are resolved as described above.

All cards are collected and a new round may begin.

In summary, in order to beat the dealer and come out ahead betting wise (not considering the results of the proposition wagers) for a particular round of this Pai Gow Poker variant game, a player needs to win both the high hand and the low hand, or win the high hand while losing the low hand.

Since there are substantially no “pushes,” (i.e., there are no overall hands wherein the player ties with the dealer), except when the dealer's hand or cards is a king-high no-pair, this present invention practically eliminates the unattractive feature of standard Pai Gow Poker wherein there is a tie between a dealer and a player.

According to some embodiments, after settling a player's “low hand” betting wager and “high hand” betting wager, the dealer shall settle any bonus betting wager(s) made by each player. A winning bonus wager shall be paid without regard to the outcome of the “low hand” betting wager and “high hand” betting wager made by the player.

As a preferred and non-limiting embodiment, here is a method of administering a Pai Gow poker variant wagering card game comprising the steps of:
providing a plurality of player positions and a dealer position at a table or a setting for a plurality of players and a dealer or a house, respectively;
prior to each player position being dealt seven cards, the dealer accepting a high hand betting wager, a low hand betting wager, and, optionally, a first bonus betting wager from each of the plurality of players to initiate play of the Pai Gow game,
wherein each of said low hand betting wager and said high hand betting wager is at or above a minimum wager for the table or the setting,
wherein said low hand betting wager and said high hand betting wager of each participating player are of unequal wagering amounts so that each participating player either wins or loses for the dealt cards received by the participating player, and
wherein said first bonus wager for each player is independent of said high hand wager and said low hand wager of the same player;
the dealer or the house dealing to each of said plurality of player positions and to said dealer position a seven-card hand formed from a set of playing cards to form at least one seven-card player hand at one or more of said plurality of player positions and to form a seven-card dealer hand at said dealer position;
each player forming a high hand with five cards from said seven-card player hand and a low hand with two cards from said seven-card player hand wherein said high hand is greater than said low hand; and
the dealer or the house, respectively, resolving said high hand and said low hand of each participating player compared to said high hand and said low hand of the dealer so that said high hand betting wager, said low hand betting wager, and said first bonus betting wager of each participating player are settled with the dealer or the house.

It is to be understood that the present invention is not limited to the embodiments described above or as shown in the attached figures, but encompasses any and all embodiments within the spirit of the invention.

1. A Pai Gow poker variant wagering card game comprising:
a table or a setting comprising a plurality of player positions and a dealer position for a plurality of players and a dealer or a house, respectively;
prior to each player position being dealt seven cards, the dealer accepting a high hand betting wager, a low hand betting wager, and, optionally, a first bonus betting wager from each of the plurality of players to initiate play of the Pai Gow game,
wherein each of said low hand betting wager and said high hand betting wager is at or above a minimum wager for the table or the setting,
wherein said low hand betting wager and said high hand betting wager of each participating player are of unequal wagering amounts so that each participating player either wins or loses for the dealt cards received by the participating player, and
wherein said first bonus wager for each player is independent of said high hand wager and said low hand wager of the same player;
the dealer or the house dealing to each of said plurality of player positions and to said dealer position a seven-card hand formed from a set of playing cards to form at least one seven-card player hand at one or more of said plurality of player positions and to form a seven-card dealer hand at said dealer position;
each player forming a high hand with five cards from said seven-card player hand and a low hand with two cards from said seven-card player hand wherein said high hand is greater than said low hand; and
the dealer or the house, respectively, resolving said high hand and said low hand of each participating player compared to said high hand and said low hand of the dealer so that said high hand betting wager, said low hand betting wager, and said first bonus betting wager of each participating player are settled with the dealer or the house.

2. The game according to claim 1, wherein said low hand wager is either exactly double or exactly triple the amount of said high hand wager.

3. The game according to claim 1, further comprising the step of the dealer accepting a King High bonus betting wager from a participating player.

4. A method of administering a Pai Gow poker variant wagering card game comprising the steps of:
providing a plurality of player positions and a dealer position at a table or a setting for a plurality of players and a dealer or a house, respectively;
prior to each player position being dealt seven cards, the dealer accepting a high hand betting wager, a low hand betting wager, and, optionally, a first bonus betting wager from each of the plurality of players to initiate play of the Pai Gow game,
wherein each of said low hand betting wager and said high hand betting wager is at or above a minimum wager for the table or the setting,
wherein said low hand betting wager and said high hand betting wager of each participating player are of unequal wagering amounts so that each participating player either wins or loses for the dealt cards received by the participating player, and
wherein said first bonus wager for each player is independent of said high hand wager and said low hand wager of the same player;
the dealer or the house dealing to each of said plurality of player positions and to said dealer position a seven-card hand formed from a set of playing cards to form at least one seven-card player hand at one or more of said plurality of player positions and to form a seven-card dealer hand at said dealer position;
each player forming a high hand with five cards from said seven-card player hand and a low hand with two cards from said seven-card player hand wherein said high hand is greater than said low hand; and
the dealer or the house, respectively, resolving said high hand and said low hand of each participating player compared to said high hand and said low hand of the dealer so that said high hand betting wager, said low hand betting wager, and said first bonus betting wager of each participating player are settled with the dealer or the house.

5. The method according to claim 4, wherein said high hand wager is either exactly double or exactly triple the amount of said low hand wager.

6. The method according to claim 4, further comprising the step of the dealer accepting a King High bonus betting wager from a participating player.
